(19) United States
(12) Patent Application Publication
(10) Pub. No.: US 2024/0326588 A1
(43) Pub. Date: Oct. 3, 2024

(54) INTEGRATED PROPULSION AND WINCH APPARATUS FOR ELECTRIC TRACTION MOTOR

(71) Applicants: Hyundai Motor Company, Seoul (KR); Kia Corporation, Seoul (KR)

(72) Inventor: Brian Link, Superior Township, MI (US)

(21) Appl. No.: 18/127,992

(22) Filed: Mar. 29, 2023

(51) Int. Cl. B60K 25/02; B60K 6/36; B60K 6/387; B66D 3/00

(52) U.S. Cl. CPC B60K 25/02; B60K 6/36; B60K 6/387; B66D 3/006; B60K 2025/022

(57) ABSTRACT

Systems configured to enable independent and simultaneous operation of winching and propulsion systems via a single traction motor are provided. The system may comprise a propulsion system configured to propel a vehicle, a winching system comprising a winch coupled to the vehicle, a battery, an output gear train, and an electric traction motor configured to direct power flow from the battery to the propulsion system and the winching system via the output gear train.

### BACKGROUND

### Technical Field

Embodiments of the present disclosure relate to systems configured to enable independent and simultaneous operation of winching and propulsion systems via a single traction motor.

### Background

To facilitate off-road recovery, a winch is typically used to aid to help pull a vehicle on which the winch is installed, or other vehicles, from situations which limit traction of the tires (e.g., mud, snow, ice, etc). Winches are usually added to a vehicle as an aftermarket part and are typically not offered from the original equipment manufacturer (OEM).

Traditional winching systems rely on their own electric motors and/or are powered via some other means (e.g., hydraulic means). Additionally, traditional winching systems typically can only provide a single function (e.g., providing winching capabilities).

Currently, no such integrated approach exists that combines both the functions of a winching system and the propulsion from a vehicle to enable independent and simultaneous operation of each system via a single traction motor.

### SUMMARY

According to an object of the present disclosure, a system is provided. The system may comprise a propulsion system configured to propel a vehicle, a winching system comprising a winch coupled to the vehicle, a battery, an output gear train, and an electric traction motor configured to direct power flow from the battery to the propulsion system and the winching system via the output gear train.

According to an exemplary embodiment, the propulsion system may comprise a differential, one or more axles, and a plurality of wheels. The propulsion system may be configured to cause the plurality of wheels to rotate.

According to an exemplary embodiment, the propulsion system may comprise a clutch configured to selectively enable and disable power flow from the battery to the propulsion system.

According to an exemplary embodiment, the clutch may comprise a friction clutch.

According to an exemplary embodiment, the winching system may comprise a clutch configured to selectively enable and disable power flow from the battery to the winching system.

According to an exemplary embodiment, the clutch may comprise a dog clutch.

According to an object of the present disclosure, a system is provided. The system may comprise a vehicle. The vehicle may comprise a propulsion system configured to propel the vehicle, a winching system comprising a winch, a battery, an output gear train, and an electric traction motor configured to direct power flow from the battery to the propulsion system and the winching system via the output gear train. The propulsion system may comprise a propulsion system clutch configured to selectively enable and disable power flow from the battery to the propulsion system, and the winching system may comprise a winching system clutch configured to selectively enable and disable power flow from the battery to the winching system.

According to an exemplary embodiment, the vehicle may be configured to function in four power flow states. The four power flow states may comprise a propulsion state wherein, in the propulsion state, power flow to the propulsion system is enabled and power flow to the winching system is disabled, a winching state wherein, in the winching state, power flow to the propulsion system is disabled and power flow to the winching system is enabled, a propulsion and winching state wherein, in the propulsion and winching state, power flow to the propulsion system is enabled and power flow to the winching system is enabled, and a neutral state wherein, in the neutral state, power flow to the propulsion system is disabled and power flow to the winching system is disabled.

According to an exemplary embodiment, the propulsion system may comprise a differential, one or more axles, and a plurality of wheels, and the propulsion system may be configured to cause the plurality of wheels to rotate.

According to an exemplary embodiment, the propulsion system clutch may comprise a friction clutch.

According to an exemplary embodiment, the winching system clutch may comprise a dog clutch.

According to an object of the present disclosure, a system is provided. The system may comprise a vehicle. The vehicle may comprise a propulsion system configured to propel the vehicle, a modular system, a battery, an output gear train, and an electric traction motor configured to direct power flow from the battery to the propulsion system and the modular system via the output gear train. The propulsion system may comprise a propulsion system clutch configured to selectively enable and disable power flow from the battery to the propulsion system, and the modular system may comprise a modular system clutch configured to selectively enable and disable power flow from the battery to the winching system.

According to an exemplary embodiment, the vehicle may be configured to function in four power flow states. The four power flow states may comprise a propulsion state wherein, in the propulsion state, power flow to the propulsion system is enabled and power flow to the modular system is disabled, a modular state wherein, in the modular state, power flow to the propulsion system is disabled and power flow to the modular system is enabled, a propulsion and modular state wherein, in the propulsion and modular state, power flow to the propulsion system is enabled and power flow to the modular system is enabled, and a neutral state wherein, in the neutral state, power flow to the propulsion system is disabled and power flow to the modular system is disabled.

According to an exemplary embodiment, the propulsion system may comprise a differential, one or more axles, and a plurality of wheels, and the propulsion system may be configured to cause the plurality of wheels to rotate.

According to an exemplary embodiment, the modular system may comprise a splined input shaft configured to enable the modular system to be attached to the vehicle, and the modular system to be removed from the vehicle.

According to an exemplary embodiment, the modular system may comprise a water pump system, comprising a water pump configured to siphon water.

According to an exemplary embodiment, the modular system may comprise an air compressor system, comprising an air compressor and an air tank.

According to an exemplary embodiment, the air compressor system may comprises one or more air tools coupled to the air compressor, and the air compressor may be configured to power the one or more air tools.

According to an exemplary embodiment, the modular system may comprise an hydraulic pump system, comprising an hydraulic pump and an hydraulic fluid reservoir.

According to an exemplary embodiment, the hydraulic system may comprise one or more hydraulic tools, and the hydraulic pump may be configured to power the one or more hydraulic tools.

### BRIEF DESCRIPTION OF THE DRAWINGS

The accompanying drawings, which are incorporated in and form a part of the Detailed Description, illustrate various non-limiting and non-exhaustive embodiments of the subject matter and, together with the Detailed Description, serve to explain principles of the subject matter discussed below. Unless specifically noted, the drawings referred to in this Brief Description of Drawings should be understood as not being drawn to scale and like reference numerals refer to like parts throughout the various figures unless otherwise specified.

FIG. 1 illustrates a system comprising a combined front winching system with front traction motor drive unit, according to an exemplary embodiment of the present disclosure.

FIG. 2 illustrates a system comprising an integrated/combined winch and propulsion system with clutching elements, according to an exemplary embodiment of the present disclosure.

FIG. 3A illustrates a system comprising an integrated/combined winching system and propulsion system with clutching elements with power flow to a propulsion system, according to an exemplary embodiment of the present disclosure.

FIG. 3B illustrates a system comprising an integrated/combined winching system and propulsion system with clutching elements with power flow to a winching system, according to an exemplary embodiment of the present disclosure.

FIG. 3C illustrates a system comprising an integrated/combined winching system and propulsion system with clutching elements with power flow to a propulsion system and a winching system, according to an exemplary embodiment of the present disclosure.

FIG. 3D illustrates a system comprising an integrated/combined winching system and propulsion system with clutching elements with power flow in a neutral state, according to an exemplary embodiment of the present disclosure.

FIG. 4 illustrates a modular system comprising an integrated/combined winching system and propulsion system with clutching elements, according to an exemplary embodiment of the present disclosure.

FIG. 5 illustrates a system comprising an integrated/combined water pump system and propulsion system with clutching elements, according to an exemplary embodiment of the present disclosure.

FIG. 6 illustrates a system comprising an integrated/combined air compressor system and propulsion system with clutching elements, according to an exemplary embodiment of the present disclosure.

FIG. 7 illustrates a system comprising an integrated/combined hydraulic pump system and propulsion system with clutching elements, according to an exemplary embodiment of the present disclosure.

FIG. 8 illustrates example elements of a computing device, according to an exemplary embodiment of the present disclosure.

FIG. 9 illustrates an example architecture of a vehicle, according to an exemplary embodiment of the present disclosure.

### DETAILED DESCRIPTION

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system as disclosed herein.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

According to an exemplary embodiment, systems and methods are provided for enabling independent and simultaneous operation of winching and propulsion systems via a single traction motor.

Winches are usually added to a vehicle as an aftermarket part but, with the growth in off-road packages directly from the original equipment manufacturer (OEM), it is beneficial to offer this capability from the manufacturer, improving the off-road image of the vehicle, especially in the electric vehicle segment. Due to the fact that electric vehicles already have powerful traction motors for propulsion, these powerful traction motors may be leveraged to power auxiliary devices, such as, e.g., a winching system. This eliminates the need to have a separate motor to power the winching system.

Additionally, the winching system and propulsion system may be run independently (or in conjunction) using a system of clutching devices (e.g., dog clutch, clutch pack, etc.) to enable the flow of torque to each of these systems independently during recovery operations.

According to an exemplary embodiment, the winching system may be connected to a traction motor via a dog clutch, while the differential/wheels may be connected to the traction motor via, e.g., a clutch pack.

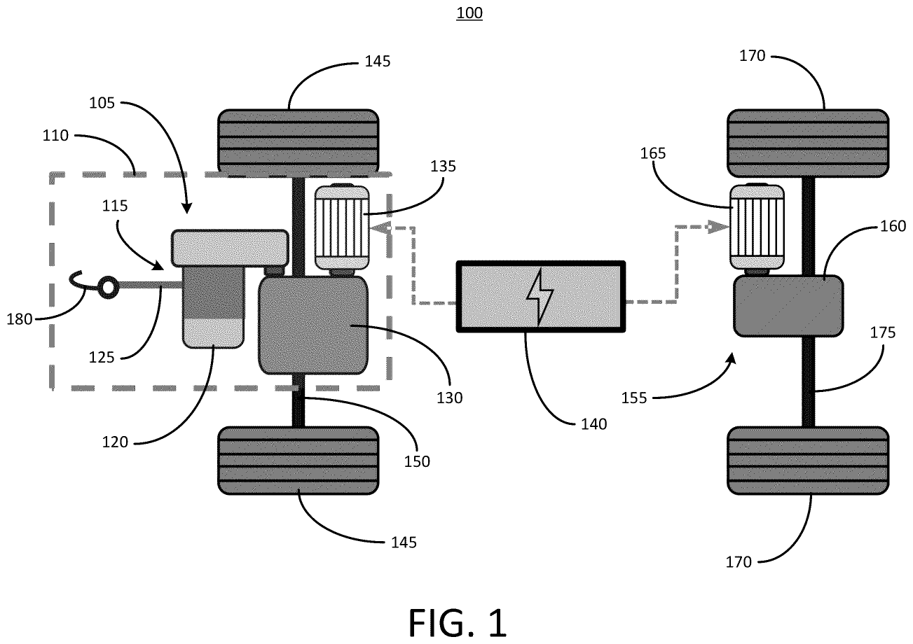

Referring now to FIG. 1, a system 100 comprising a combined front winching system 105 with front traction motor drive unit 110 of an electric vehicle, is illustratively depicted, in accordance with an exemplary embodiment of the present disclosure.

The system 100 may comprise a winching system 105 as a component of a front traction motor drive unit 110, comprising a winch 115 with spool 120 and winch line 125, a gearbox and differential 130, and a front electric motor 135 coupled to a battery 140. According to an exemplary embodiment, the winch 115 may comprise a connecting mechanism (e.g., hook 180) configured to enable the winch line 125 to be secured to one or more objects.

According to an exemplary embodiment, the front traction motor drive unit 110 may be configured to enable rotation and/or braking of the front wheels 145 coupled to a front axle 150 via the differential 130. According to an exemplary embodiment, the system 100 may comprise a rear traction motor drive unit 155, comprising a differential 160 and a rear electric motor 165 coupled to the battery 140. According to an exemplary embodiment, the rear traction motor drive unit 155 may be configured to enable rotation and/or braking of the rear wheels 170 coupled to a rear axle 175 via the differential 160. According to an exemplary embodiment, the front traction motor drive unit 110 and the rear traction motor drive unit 155 may be coupled to a same battery 140 and/or to one or more different batteries.

While system 100 is described in terms of “front” and “rear,” it is noted that the system 100 and its components may be configured in any suitable organizational configuration.

According to an exemplary embodiment, winching capability (via, e.g., a winching system 105) may be added as an additional functionality to an electric vehicle traction motor and through a specific configuration of the output path to enable a single motor to provide four discrete states of operation: propulsion; winching; propulsion and winching; and a neutral state. Using a common power source (e.g., battery 140) to provide both propulsion and winching is an efficient way to add winching functionality to an electric vehicle.

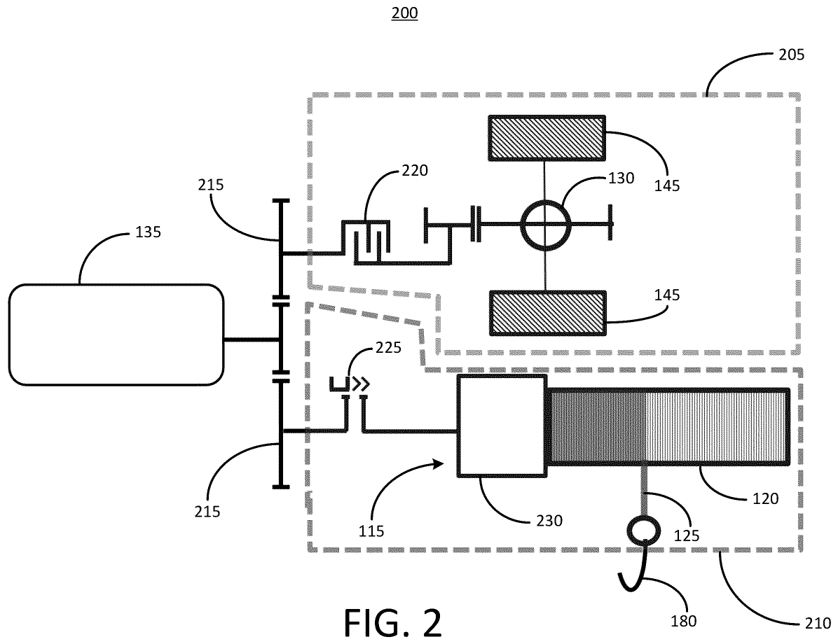

According to an exemplary embodiment, the addition of one or more clutching elements may be configured to enable a selection of torque flow to one or more of the differential 130, driven wheels 145, and winch 115, as shown in system 200 illustrating an integrated/combined winching system 210 and propulsion system 205 with clutching elements 220, 225, as shown in FIG. 2.

According to an exemplary embodiment, the system 200 may be configured to enable two selectable torque paths, both of which may be enabled individually and/or simultaneously, from a traction motor output. According to an exemplary embodiment, the two selectable torque paths may comprise a path 205 for propulsion to the wheels 145 and a path 210 for torque to provide winching capability.

According to an exemplary embodiment, output from a traction motor 135 may be split via, e.g., an output gear train 215 to the propulsion system 205 and the winching system 210. According to an exemplary embodiment, the power flow for the propulsion system 205 to the differential 130 and driven wheels 145 may be controlled and/or regulated by a designated clutch (e.g., friction clutch 220). The friction clutch 220 may be configured to enable modulation of torque to the wheels 145 via a slip ratio of the drive/driven clutch discs.

Modulation is critical when both winching and propulsion functions are needed, as the motor 135 provides a single torque output. Independent modulation of the wheel speed may be needed to aid in recovery of the vehicle when both the propulsion system 205 and winching system 210 are being used at the same time. According to an exemplary embodiment, when only the propulsion system 205 is needed, the friction clutch 220 may be engaged 100% and the motor 135 may be configured to control the wheel torque discretely.

According to an exemplary embodiment, the torque path for winching capability by the winching system 210 may be selected via a designated clutch (e.g., dog clutch 225) and/or other suitable on/off-type engagement device. According to an exemplary embodiment, the dog clutch 225 may be configured to engage two rotating shafts through an interference fit (e.g., constant mesh). The dog clutch 225 may be configured to provide a simple way to engage the winch 115 on demand and allow for 100% torque transfer to the winch 115. According to an exemplary embodiment, a winching speed of the winch 115 may be proportional to an output speed of the traction motor 135. According to an exemplary embodiment, the winch 115 may comprise a gearbox 230 (e.g., a planetary gearbox) configured to provide adequate torque multiplication to pull the vehicle and spool the winch line 125 onto the winch spool 115.

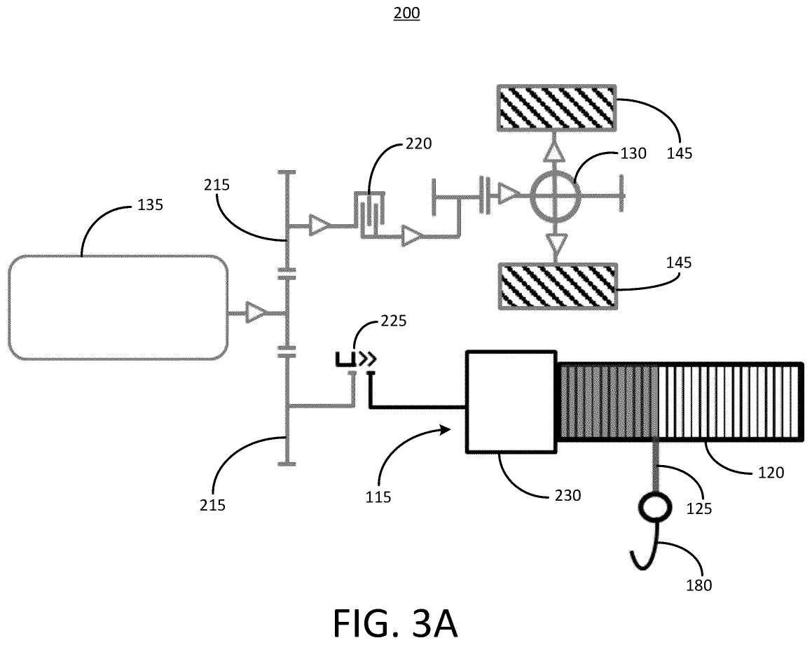

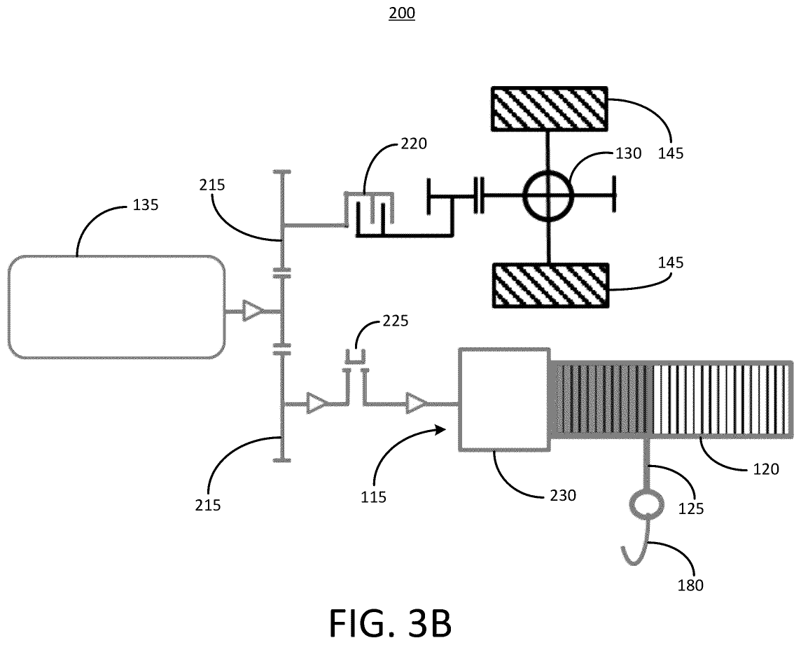

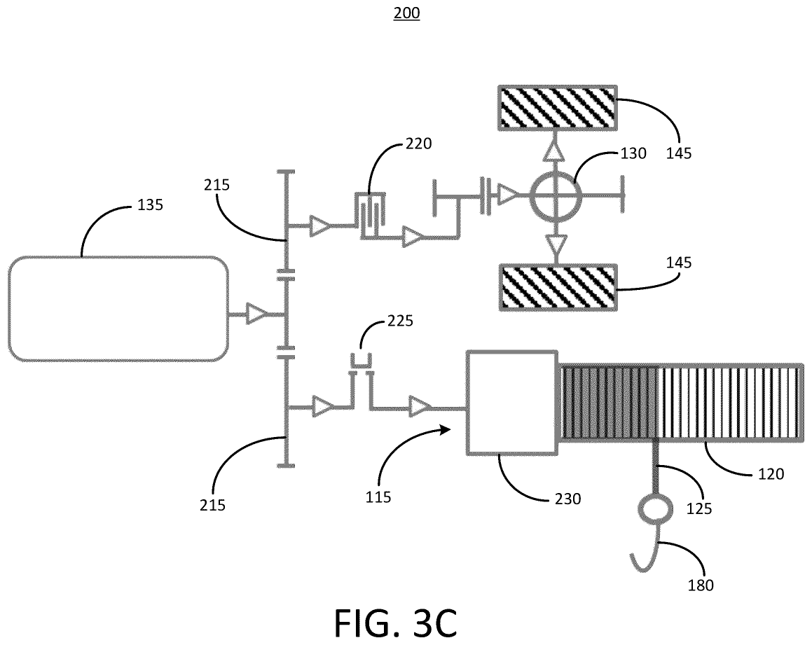

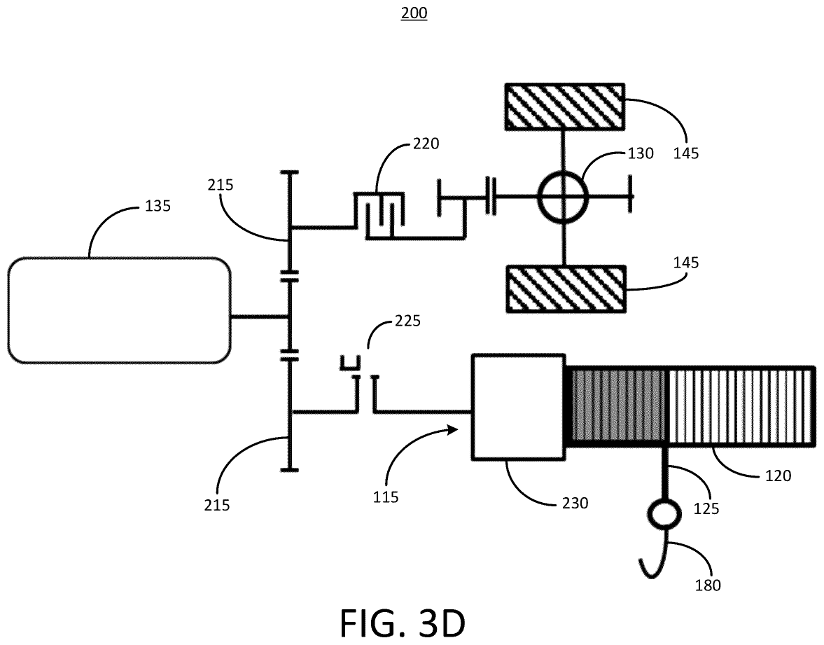

According to an exemplary embodiment, the systems of the present disclosure (e.g., systems 100 and 200) may be configured to enable four distinct power flow states. FIG. 3A illustrates system diagram 200 with power flow for the propulsion system 205 (propulsion-only state), FIG. 3B illustrates system diagram 200 with power flow for the winching system 210 (winching-only state), FIG. 3C illustrates system diagram 200 with power flow for the propulsion system 205 and the winching system 210 (winching and propulsion state), and FIG. 3D illustrates system diagram 200 with power flow in a neutral power state, in accordance with exemplary embodiments of the present disclosure.

According to an exemplary embodiment, the propulsion-only state (as shown in FIG. 3A) may be accomplished by engagement of the friction clutch 220. Since the traction motor 135 may be configured to regulate speed/torque to the wheels 145 in the propulsion-only state, the friction clutch 220 may be engaged to 100% with no slip. In the propulsion-only state, torque may be transmitted directly from the traction motor 135 to the output gear train 215 to the friction clutch 220, to the differential 130, and to the driven wheels 145.

According to an exemplary embodiment, the winch-only power state (as shown in FIG. 3B) may be accomplished by engagement of the dog clutch 225. When power flows to the winching system 210, regulation of the winching speed/torque may be dependent on the output of the traction motor 135. In the winch-only state, torque may be transmitted directly from the traction motor 135 to the output gear train 215, to the dog clutch 225, to the winch gearbox 230, and to the spool 120 and winch line 125.

According to an exemplary embodiment, the winching and propulsion state (as shown in FIG. 3C) enables simultaneous operation of the propulsion system 205 and the winching system 210 and may be accomplished by utilizing both the friction clutch 220 and the dog clutch 225. According to an exemplary embodiment, using the propulsion system 205, to achieve speed/torque regulation of the propulsion/driven wheels 145, the friction clutch 220 may be slipped to generate an appropriate clutch torque to meet a driver's intention (e.g., based on accelerator pedal input). According to an exemplary embodiment, torque flow to the winching system 210 may be dictated by an overall output of the traction motor 135 via the dog clutch 225. In the winching and propulsion state, torque may be transmitted directly from the traction motor 135 to the output gear train 215, and then split between two functions. In the first (propulsion) function, torque may be transmitted from the output gear train 215 to the friction clutch 220, to the differential 130, and to the driven wheels 145. In the second (winching) function, torque may be transmitted from the output gear train 215, to the dog clutch 225, to the winch gearbox 230, and to the spool 120 and winch line 125. According to an exemplary embodiment, since a single source of output torque is being shared by both the propulsion system 205 and the winching system 210, the total available torque available to each system will be less than the total output torque.

According to an exemplary embodiment, the neutral power state (as shown in FIG. 3D) may be accomplished by disengagement of both the friction clutch 220 and the dog clutch 225.

According to an exemplary embodiment, by utilizing two selectable power flow paths (e.g., the power flow path to the propulsion system 205 and the power flow path to the winching system 210), all existing functionality of the vehicle may be retained with the benefit of independent winch operation being added. Vehicle recovery can be complex and may require some combination of winching and tractive effort, therefore allowing both traction and winching to be operated independently from the same traction motor 135 eliminates the need for an independent power source for the winching system 210.

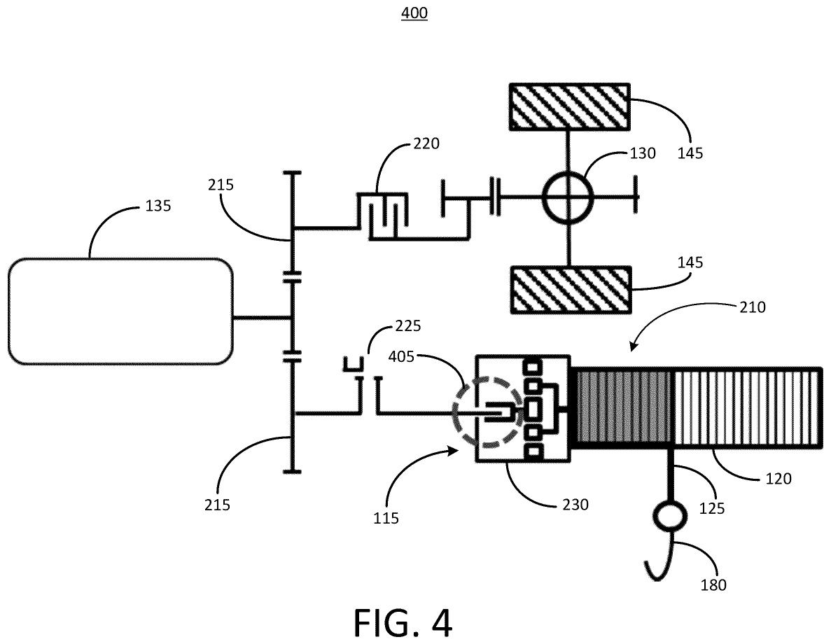

According to an exemplary embodiment, the winch system 210 of the present disclosure may be configured to be modular such as shown, e.g., in system 400 of FIG. 4.

According to an exemplary embodiment, by making the winch system 210 a modular system, there is potential to expand use cases with additional accessories which may aid the driver and take advantage of the ability to separate a traction and accessory drive.

As shown in FIG. 4, modularity may be achieved by utilizing a splined input shaft 405. It is noted, however, that one or more other suitable means for enabling modularity may be incorporated, while maintaining the spirit and functionality of the present disclosure. According to an exemplary embodiment, the splined input shaft 405 may be configured to enable the winch 115 to be removed and swapped with one or more other accessories that may benefit from the potential of the traction motor 135, enabling the modular system to be removed from the vehicle and/or attached to the vehicle.

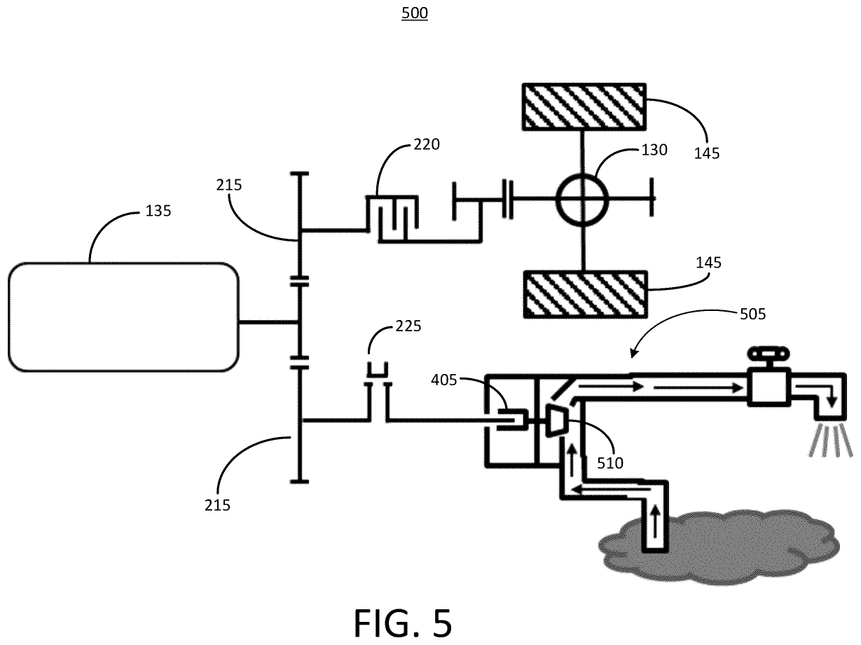

For example, additional accessories and functionalities that may be swapped in place of the winching system 210 and driven by power flow through the dog clutch 225 may comprise, but are not limited to, a water pump system 505 (as shown, e.g., in system 500 of FIG. 5) comprising, e.g., a water pump 510 configured to siphon water from a stream, lake, or other body of water to provide a pressurized source of water. It is noted, however, that the water pump system 505 may be configured to siphon other liquids in addition to or instead of water, while maintaining the spirit and functionality of the present disclosure.

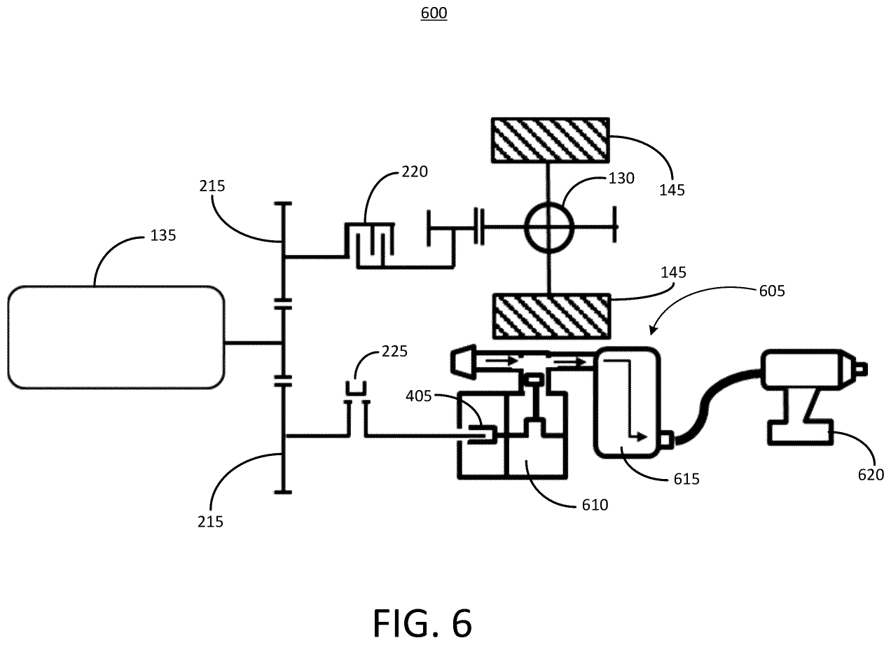

By further way of example, additional accessories and functionalities that may be swapped in place of the winching system 210 and driven by power flow through the dog clutch 225 may comprise, but are not limited to, an air compressor system 605 (as shown, e.g., in system 600 of FIG. 6) comprising, e.g., an air compressor 610, an air tank 615, and/or one or more air tools 620. According to an exemplary embodiment, the air compressor system 605 may be configured to enable a driver to fill tires with air and utilize the one or more air tools 620 (e.g., an impact gun and/or one or more other suitable air tools) to aid in on-road and off-road repairs. The high power output of the traction motor 135 may be configured to power a larger, higher flow air compressor (e.g., an air compressor more powerful than a typical 12V-powered air compressor).

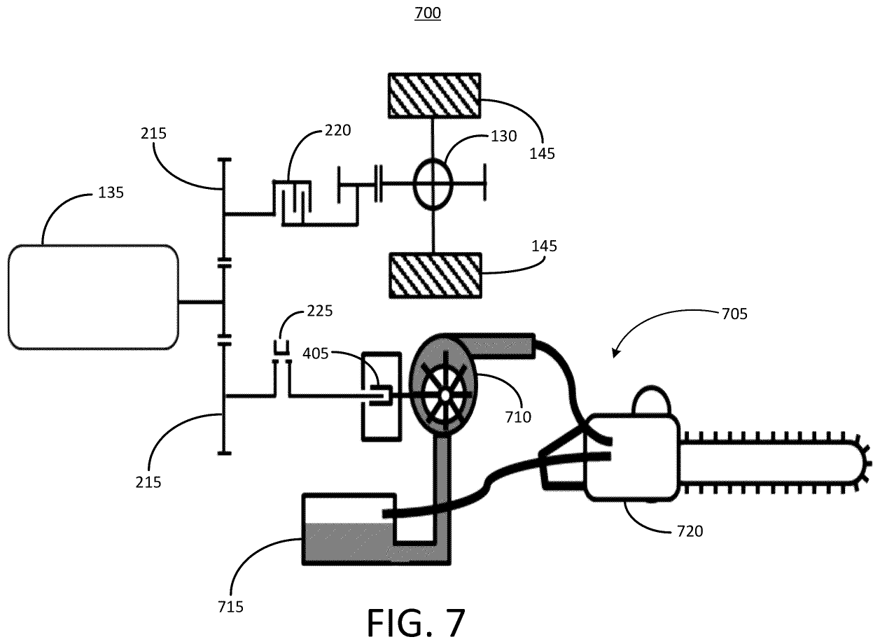

By further way of example, additional accessories and functionalities that may be swapped in place of the winching system 210 and driven by power flow through the dog clutch 225 may comprise, but are not limited to, an hydraulic pump system 705 (as shown, e.g., in system 700 of FIG. 7) comprising, e.g., an hydraulic pump 710, an hydraulic fluid reservoir 715, and/or one or more hydraulic tools 720 (e.g., a car jack, an hydraulic chainsaw, a log splitter, and/or one or more other suitable hydraulic tools). According to an exemplary embodiment, the hydraulic pump 710 may be configured to power the one or more hydraulic tools 720.

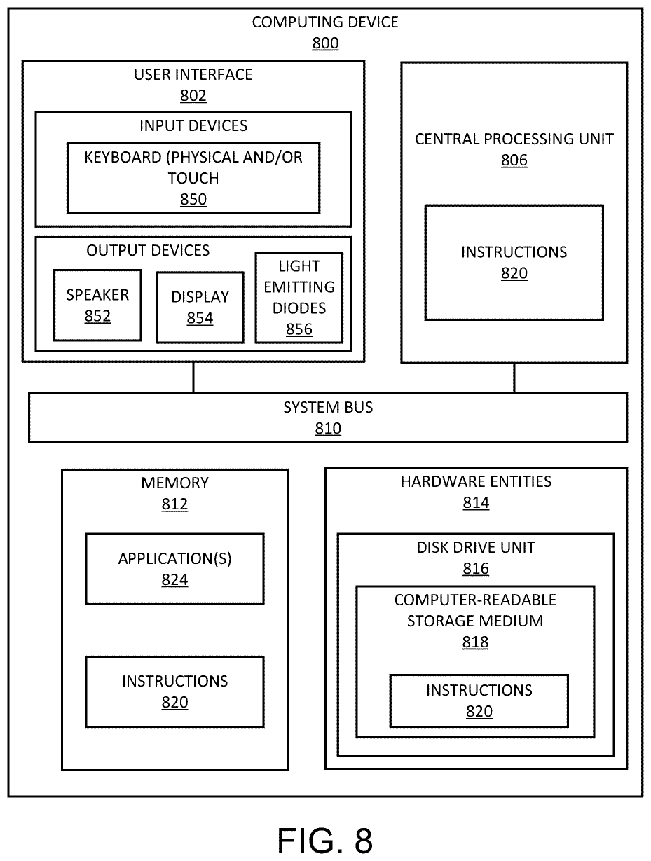

Referring now to FIG. 8, an illustration of an example architecture for a computing device 800 is provided. According to an exemplary embodiment, one or more functions of the present disclosure may be implemented by a computing device such as, e.g., computing device 800 or a computing device similar to computing device 800.

The hardware architecture of FIG. 8 represents one example implementation of a representative computing device configured to implement at least a portion of the functions of the system(s) described herein (e.g., systems 100, 200, 400, 500, 600, and 700).

Some or all components of the computing device 800 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors). The passive and/or active components may be adapted to, arranged to, and/or programmed to perform one or more of the methodologies, procedures, or functions described herein.

As shown in FIG. 8, the computing device 800 may comprise a user interface 802, a Central Processing Unit (“CPU”) 806, a system bus 810, a memory 812 connected to and accessible by other portions of computing device 800 through system bus 810, and hardware entities 814 connected to system bus 810. The user interface may comprise input devices and output devices, which may be configured to facilitate user-software interactions for controlling operations of the computing device 800. The input devices may comprise, but are not limited to, a physical and/or touch keyboard 840. The input devices may be connected to the computing device 800 via a wired or wireless connection (e.g., a Bluetooth® connection). The output devices may comprise, but are not limited to, a speaker 842, a display 844, and/or light emitting diodes 846.

At least some of the hardware entities 814 may be configured to perform actions involving access to and use of memory 812, which may be a Random Access Memory (RAM), a disk driver and/or a Compact Disc Read Only Memory (CD-ROM), among other suitable memory types. Hardware entities 814 may comprise a disk drive unit 816 comprising a computer-readable storage medium 818 on which may be stored one or more sets of instructions 820 (e.g., programming instructions such as, but not limited to, software code) configured to implement one or more of the methodologies, procedures, or functions described herein. The instructions 820 may also reside, completely or at least partially, within the memory 812 and/or within the CPU 806 during execution thereof by the computing device 800.

The memory 812 and the CPU 806 may also constitute machine-readable media. The term “machine-readable media”, as used here, refers to a single medium or multiple media (e.g., a centralized or distributed database, and/or associated caches and servers) that store the one or more sets of instructions 820. The term “machine-readable media”, as used here, also refers to any medium that is capable of storing, encoding or carrying a set of instructions 820 for execution by the computing device 800 and that cause the computing device 800 to perform any one or more of the methodologies of the present disclosure.

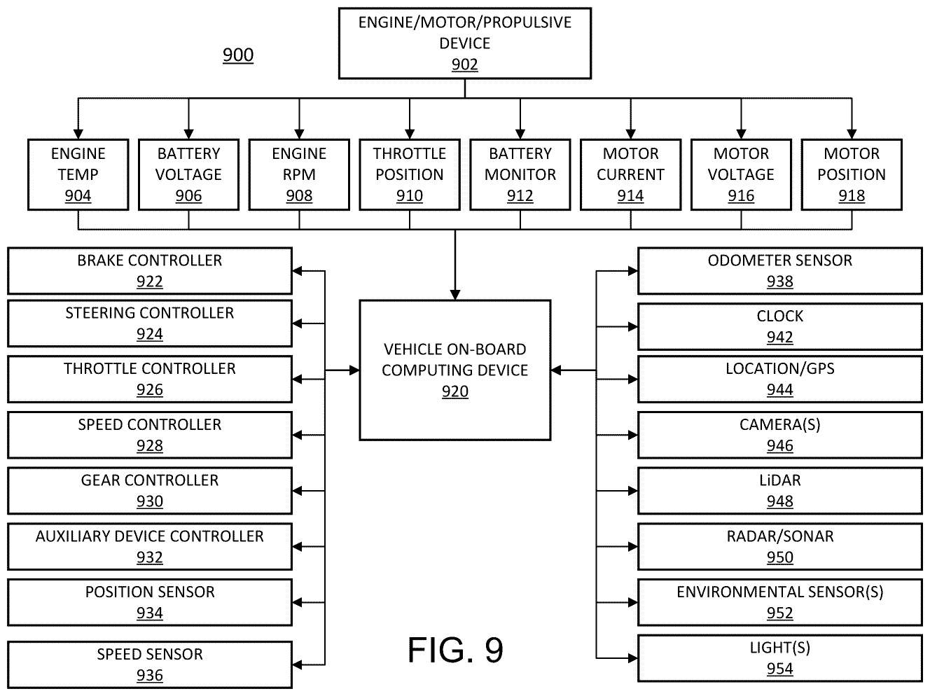

Referring now to FIG. 9, an example vehicle system architecture 900 for a vehicle is provided, in accordance with an exemplary embodiment of the present disclosure.

Systems 100, 200, 400, 500, 600, and 700 may be configured to be incorporated in or with a vehicle having the same or similar system architecture as that shown in FIG. 9. Thus, the following discussion of vehicle system architecture 900 is sufficient for understanding one or more components of a vehicle into or with which systems 100, 200, 400, 500, 600, and 700 may be incorporated.

As shown in FIG. 9, the vehicle system architecture 900 may comprise an engine, motor or propulsive device (e.g., a thruster) 902 and various sensors 904-918 for measuring various parameters of the vehicle system architecture 900. In gas-powered or hybrid vehicles having a fuel-powered engine, the sensors 904-918 may comprise, for example, an engine temperature sensor 904, a battery voltage sensor 906, an engine Rotations Per Minute (RPM) sensor 908, and/or a throttle position sensor 910. If the vehicle is an electric or hybrid vehicle, then the vehicle may comprise an electric motor, and accordingly may comprise sensors such as a battery monitoring system 912 (to measure current, voltage and/or temperature of the battery), motor current 914 and voltage 916 sensors, and motor position sensors such as resolvers and encoders 918.

Operational parameter sensors that are common to both types of vehicles may comprise, for example: a position sensor 934 such as an accelerometer, gyroscope and/or inertial measurement unit; a speed sensor 936; and/or an odometer sensor 938. The vehicle system architecture 900 also may comprise a clock 942 that the system uses to determine vehicle time and/or date during operation. The clock 942 may be encoded into the vehicle on-board computing device 920, it may be a separate device, or multiple clocks may be available.

The vehicle system architecture 900 also may comprise various sensors that operate to gather information about the environment in which the vehicle is traveling. These sensors may comprise, for example: a location sensor 944 (for example, a Global Positioning System (GPS) device); object detection sensors such as one or more cameras 946; a LiDAR sensor system 948; and/or a RADAR and/or a sonar system 950. The sensors also may comprise environmental sensors 952 such as, e.g., a humidity sensor, a precipitation sensor, a light sensor, and/or ambient temperature sensor. The object detection sensors may be configured to enable the vehicle system architecture 900 to detect objects that are within a given distance range of the vehicle in any direction, while the environmental sensors 952 may be configured to collect data about environmental conditions within the vehicle's area of travel. According to an exemplary embodiment, the vehicle system architecture 900 may comprise one or more lights 954 (e.g., headlights, flood lights, flashlights, etc.).

During operations, information may be communicated from the sensors to an on-board computing device 920 (e.g., computing device 800 of FIG. 8). The on-board computing device 920 may be configured to analyze the data captured by the sensors and/or data received from data providers and may be configured to optionally control operations of the vehicle system architecture 900 based on results of the analysis. For example, the on-board computing device 920 may be configured to control: braking via a brake controller 922; direction via a steering controller 924; speed and acceleration via a throttle controller 926 (in a gas-powered vehicle) or a motor speed controller 928 (such as a current level controller in an electric vehicle); a differential gear controller 930 (in vehicles with transmissions); and/or other controllers. The brake controller 922 may comprise a pedal effort sensor, pedal effort sensor, and/or simulator temperature sensor, as described herein.

Geographic location information may be communicated from the location sensor 944 to the on-board computing device 920, which may then access a map of the environment that corresponds to the location information to determine known fixed features of the environment such as streets, buildings, stop signs and/or stop/go signals. Captured images from the cameras 946 and/or object detection information captured from sensors such as LiDAR 948 may be communicated from those sensors to the on-board computing device 920. The object detection information and/or captured images may be processed by the on-board computing device 920 to detect objects in proximity to the vehicle. Any known or to be known technique for making an object detection based on sensor data and/or captured images may be used in the embodiments disclosed in this document.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

What is claimed is:

1. A system, comprising:
a propulsion system configured to propel a vehicle;
a winching system comprising a winch coupled to the vehicle;
a battery;
an output gear train; and
an electric traction motor configured to direct power flow from the battery to the propulsion system and the winching system via the output gear train.

2. The system of claim 1, wherein:
the propulsion system comprises:
a differential;
one or more axles; and
a plurality of wheels, and
the propulsion system is configured to cause the plurality of wheels to rotate.

3. The system of claim 1, wherein the propulsion system comprises a clutch configured to selectively enable and disable power flow from the battery to the propulsion system.

4. The system of claim 3, wherein the clutch comprises a friction clutch.

5. The system of claim 1, wherein the winching system comprises a clutch configured to selectively enable and disable power flow from the battery to the winching system.

6. The system of claim 5, wherein the clutch comprises a dog clutch.

7. A system, comprising:
a vehicle, comprising:
a propulsion system configured to propel the vehicle;
a winching system comprising a winch;
a battery;
an output gear train; and
an electric traction motor configured to direct power flow from the battery to the propulsion system and the winching system via the output gear train,
wherein:
the propulsion system comprises a propulsion system clutch configured to selectively enable and disable power flow from the battery to the propulsion system, and
the winching system comprises a winching system clutch configured to selectively enable and disable power flow from the battery to the winching system.

8. The system of claim 7, wherein the vehicle is configured to function in four power flow states, the four power flow states comprising:
a propulsion state wherein, in the propulsion state, power flow to the propulsion system is enabled and power flow to the winching system is disabled;
a winching state wherein, in the winching state, power flow to the propulsion system is disabled and power flow to the winching system is enabled;
a propulsion and winching state wherein, in the propulsion and winching state, power flow to the propulsion system is enabled and power flow to the winching system is enabled; and
a neutral state wherein, in the neutral state, power flow to the propulsion system is disabled and power flow to the winching system is disabled.

9. The system of claim 7, wherein:
the propulsion system comprises:
a differential;
one or more axles; and
a plurality of wheels, and
the propulsion system is configured to cause the plurality of wheels to rotate.

10. The system of claim 7, wherein the propulsion system clutch comprises a friction clutch.

11. The system of claim 7, wherein the winching system clutch comprises a dog clutch.

12. A system, comprising:
a vehicle, comprising:
a propulsion system configured to propel the vehicle;
a modular system;
a battery;
an output gear train; and
an electric traction motor configured to direct power flow from the battery to the propulsion system and the modular system via the output gear train,
wherein:
the propulsion system comprises a propulsion system clutch configured to selectively enable and disable power flow from the battery to the propulsion system, and
the modular system comprises a modular system clutch configured to selectively enable and disable power flow from the battery to the winching system.

13. The system of claim 12, wherein the vehicle is configured to function in four power flow states, the four power flow states comprising:
a propulsion state wherein, in the propulsion state, power flow to the propulsion system is enabled and power flow to the modular system is disabled;
a modular state wherein, in the winching state, power flow to the propulsion system is disabled and power flow to the modular system is enabled;
a propulsion and modular state wherein, in the propulsion and modular state, power flow to the propulsion system is enabled and power flow to the modular system is enabled; and
a neutral state wherein, in the neutral state, power flow to the propulsion system is disabled and power flow to the modular system is disabled.

14. The system of claim 12, wherein:
the propulsion system comprises:
a differential;
one or more axles; and
a plurality of wheels, and
the propulsion system is configured to cause the plurality of wheels to rotate.

15. The system of claim 12, wherein the modular system comprises a splined input shaft configured to enable:
the modular system to be attached to the vehicle; and
the modular system to be removed from the vehicle.

16. The system of claim 12, wherein the modular system comprises a water pump system, comprising a water pump configured to siphon water.

17. The system of claim 12, wherein the modular system comprises an air compressor system, comprising:
an air compressor; and
an air tank.

18. The system of claim 17, wherein:
the air compressor system comprises one or more air tools coupled to the air compressor, and
the air compressor is configured to power the one or more air tools.

19. The system of claim 12, wherein the modular system comprises an hydraulic pump system, comprising:
an hydraulic pump; and
an hydraulic fluid reservoir.

20. The system of claim 19, wherein:
the hydraulic system comprises one or more hydraulic tools, and
the hydraulic pump is configured to power the one or more hydraulic tools.
